(19) United States
(12) Patent Application Publication
(10) Pub. No.: US 2012/0199723 A1
(43) Pub. Date: Aug. 9, 2012

(54) SOLID-STATE IMAGING DEVICE

(75) Inventor: Yoshitaka EGAWA, Kanagawa (JP)

(73) Assignee: Kabushiki Kaisha Toshiba, Tokyo (JP)

(21) Appl. No.: 13/353,658

(22) Filed: Jan. 19, 2012

(30) Foreign Application Priority Data
Feb. 3, 2011 (JP) 2011-021622

(51) Int. Cl. H01L 27/146

(52) U.S. Cl. 250/208.1

(57) ABSTRACT

According to one embodiment, a solid-state imaging device includes: a vertical signal line through which a pixel signal read from the pixel is vertically transmitted; a level-shift circuit that shifts a potential at the vertical signal line; a level-shift control circuit that controls an amount of shifted potential at the vertical signal line; a timing control circuit that generates a control signal controlling the level-shift control circuit; and a pixel signal output control unit that controls an output of the pixel signal based on a change in potential at the vertical signal line when the potential at the vertical signal line shifted by the level-shift circuit is used as a reference.

### CROSS-REFERENCE TO RELATED APPLICATIONS

This application is based upon and claims the benefit of priority from Japanese Patent Application No. 2011-021622, filed on Feb. 3, 2011; the entire contents of which are incorporated herein by reference.

### FIELD

Embodiments described herein relate generally to a solid-state imaging device.

### BACKGROUND

Charges accumulated in a pixel overflow when strong, excessive light is incident to a CMOS image sensor. Therefore, a difference between a reset potential and a signal potential is decreased to generate a black grave image (black dot). In order to prevent from generating the black dot, there is well known a method in which the reset potential is detected and the incidence of the excessive light is detected from the detection result. In the method for detecting the reset potential, sometimes it takes a long time to sufficiently change the reset potential such that the generation of the black dot can securely be detected.

### BRIEF DESCRIPTION OF THE DRAWINGS

FIG. 1 is a block diagram illustrating a schematic configuration of a solid-state imaging device according to a first embodiment;

FIG. 2 is a circuit diagram illustrating a schematic configuration of one column of the solid-state imaging device of FIG. 1;

FIG. 3 is a timing chart illustrating an operation to read one pixel of the solid-state imaging device of FIG. 2 when a black dot is not generated;

FIG. 4 is a timing chart illustrating the operation to read one pixel of the solid-state imaging device of FIG. 2 when the black dot is generated;

FIG. 5 is a block diagram illustrating a schematic configuration of a solid-state imaging device according to a second embodiment;

FIG. 6 is a circuit diagram illustrating a schematic configuration of one column of the solid-state imaging device of FIG. 5;

FIG. 7 is a timing chart illustrating the operation to read one pixel of the solid-state imaging device of FIG. 6 when the black dot is generated;

FIG. 8 is a block diagram illustrating a schematic configuration of a solid-state imaging device according to a third embodiment;

FIG. 9 is a circuit diagram illustrating a schematic configuration of one column of the solid-state imaging device of FIG. 8;

FIG. 10 is a timing chart illustrating the operation to read one pixel of the solid-state imaging device of FIG. 9 when the black dot is generated;

FIG. 11 is a circuit diagram illustrating a schematic configuration of one column of a solid-state imaging device according to a fourth embodiment;

FIG. 12 is a block diagram illustrating a schematic configuration of a solid-state imaging device according to a fifth embodiment;

FIG. 13 is a circuit diagram illustrating a schematic configuration of one column of the solid-state imaging device of FIG. 12;

FIG. 14 is a timing chart illustrating the operation to read one pixel of the solid-state imaging device of FIG. 13 when the black dot is generated;

FIG. 15 is a circuit diagram illustrating a schematic configuration of one column of a solid-state imaging device according to a sixth embodiment;

FIG. 16 is a block diagram illustrating a schematic configuration of a solid-state imaging device according to a seventh embodiment; and

FIG. 17 is a circuit diagram illustrating a schematic configuration of one column of the solid-state imaging device of FIG. 16.

### DETAILED DESCRIPTION

In general, a pixel array unit, a vertical signal line, a level-shift circuit, a level-shift control circuit, a comparator, and a pixel signal output control unit are provided in a solid-state imaging device of an exemplary embodiment. In the pixel array unit, pixels in each of which a photoelectrically-converted charge is accumulated are two-dimensionally arrayed. A pixel signal read from the pixel is vertically transmitted through the vertical signal line. The level-shift circuit shifts a potential at the vertical signal line. The level-shift control circuit controls an amount of shifted potential at the vertical signal line. In the comparator, an operating point is set based on the potential at the vertical signal line, which is shifted by the level-shift circuit. The pixel signal output control unit controls an output of the pixel signal based on a comparison result of the potential at the vertical signal line and a reference voltage, which is performed by the comparator.

The solid-state imaging device of the exemplary embodiment will be described below with reference to the drawings. However, the invention is not limited to the following embodiments.

### First Embodiment

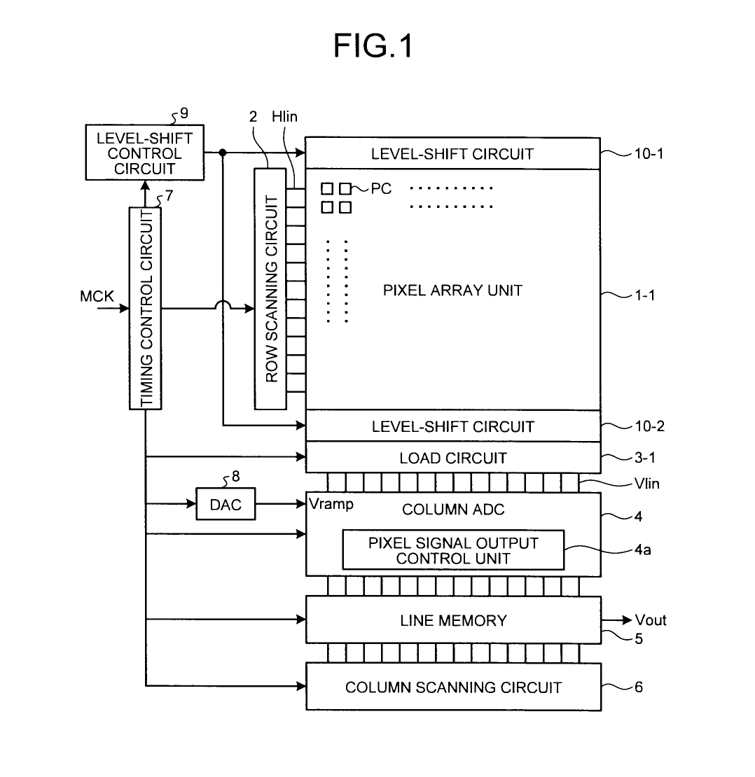

FIG. 1 is a block diagram illustrating a schematic configuration of a solid-state imaging device according to a first embodiment.

Referring to FIG. 1, a pixel array unit 1-1 in which pixels PC are two-dimensionally arrayed in a row direction and a column direction, a photoelectrically-converted charge being accumulated in the pixel PC; a row scanning circuit 2 that vertically scans the pixels PC of a read target; a load circuit 3-1 that causes a potential at a vertical signal line Vlin to follow the pixel signal read from the pixel PC; a column ADC circuit 4 that digitizes a pixel signal component of each pixel PC by a CDS; a line memory 5 in which one line of the pixel signal component of each PC digitized by the column ADC circuit 4 is stored; a column scanning circuit 6 that scans the pixels PC of the read target in a horizontal direction; a timing control circuit 7 that controls timing of the read or the accumulation of each PC; a DA converter 8 that outputs a ramp signal Vramp to the column ADC circuit 4; level-shift circuits 10-1 and 10-2 that shift the potential at the vertical signal line Vlin; and a level-shift control circuit 9 that controls the amount of shifted potential at the vertical signal line Vlin are provided in the solid-state imaging device. A master clock MCK is input to the timing control circuit 7.

The level-shift circuits 10-1 and 10-2 are vertically provided at both ends of the pixel array unit 1-1. The level-shift circuits 10-1 and 10-2 can shift the potential at the vertical signal line Vlin when a reset signal is read from the pixel PC through the vertical signal line Vlin.

A pixel signal output control unit 4a is provided in the column ADC circuit 4. The pixel signal output control unit 4a can control the output of the pixel signal based on a change in potential at the vertical signal line Vlin when the potential at the vertical signal line Vlin shifted by the level-shift circuits 10-1 and 10-2 is used as a reference.

In the pixel array unit 1-1, a horizontal control line Hlin through which the read of the pixel PC is controlled is provided in the row direction, and the vertical signal line Vlin through which the signal read from the pixel PC is transmitted is provided in the column direction.

The row scanning circuit 2 vertically scans the pixels PC to select the pixels PC in the row direction, and the signals read from the pixels PC are transmitted to the column ADC circuit 4 through the vertical signal line Vlin. In the load circuit 3-1, when the signal is read from the pixel PC, a source follower is constructed between the pixel PC and the load circuit 3-1, thereby causing the potential at the vertical signal line Vlin to follow the signal read from the PC.

In the column ADC circuit 4, a reset level and a read level are sampled from the signals of the pixels PC, a signal component of each pixel PC is digitized with the CDS by calculating a difference between the reset level and the read level, and the digitized signal component is output as an output signal Vout through the line memory 5.

At this point, the level-shift circuits 10-1 and 10-2 shift the potential at the vertical signal line Vlin when the reset signal is read from the pixel PC. The pixel signal output control unit 4a controls the column ADC circuit 4 such that a saturation signal is output as the output signal Vout when the amount of change in potential at the vertical signal line Vlin becomes equal to or more than the shift amount of the potential at the vertical signal line Vlin after the shift of the potential at the vertical signal line Vlin is released.

Therefore, the change in potential at the vertical signal line Vlin can be monitored based on the potential at the vertical signal line Vlin, which is shifted during the reset. Even if the potential at the vertical signal line Vlin varies during the reset, the incidence of the excessive light can be detected from the potential at the vertical signal line Vlin without ensuring a margin for the variation in potential. As a result, the need to wait for a long time until the potential at the vertical signal line Vlin is excessively changed during the reset is eliminated in order to be able to securely detect the generation of the black dot, so that the time necessary to detect the generation of the black dot can be shortened.

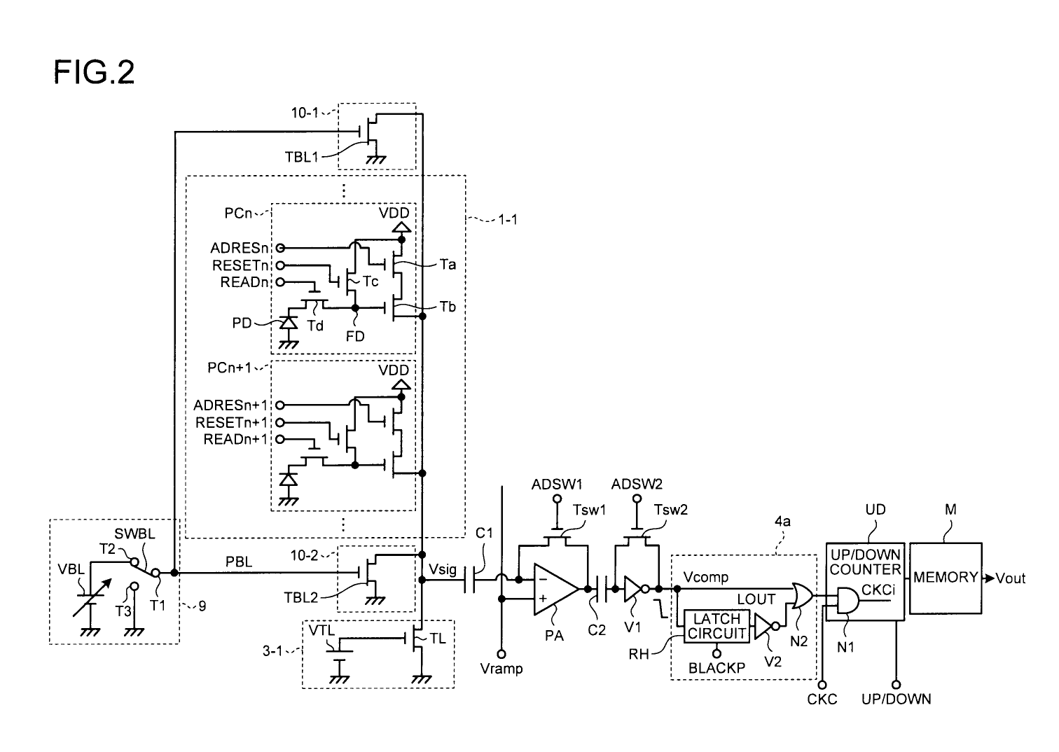

FIG. 2 is a circuit diagram illustrating a schematic configuration of one column of the solid-state imaging device of FIG. 1.

Referring to FIG. 2, pixels PCn and PCn+1 are provided in the pixel array unit 1-1, and a photodiode PD, a row selecting transistor Ta, an amplification transistor Tb, a reset transistor Tc, and read transistor Td are provided in each of the pixels PCn and PCn+1 respectively. A floating diffusion FD is formed as a detection node at a connection point of the amplification transistor Tb, the reset transistor Tc, and the read transistor Td.

In the pixels PCn and PCn+1, sources of the read transistors Td are connected to the photodiodes PD, and read signals READn and READn+1 are input to gates of the read transistors Td, respectively. Sources of the reset transistors Tc are connected to drains of the read transistors Td, reset signals RESETn and RESETn+1 are input to gates of the reset transistors Tc, respectively, and drains of the reset transistors Tc are connected to a power supply potential VDD. Row selecting signals ADRESn and ADRESn+1 are input to gates of the row selecting transistors Ta, respectively, and drains of the row selecting transistor Ta are connected to the power supply potential VDD. Sources of the amplification transistors Tb are connected to the vertical signal line Vlin, gates of the amplification transistors Tb are connected to the drains of the read transistors Td, and drains of the amplification transistors Tb are connected to the sources of the row selecting transistors Ta.

In the horizontal control line Hlin of FIG. 1, the read signals READn and READn+1, the reset signals RESETn and RESETn+1, and the row selecting signals ADRESn and ADRESn+1 can be transmitted in each row to the pixel PC.

A load transistor TL and a bias power supply VTL are provided in the load circuit 3-1. A drain of the load transistor TL is connected to the vertical signal line Vlin, and the bias power supply VTL is connected to a gate of the load transistor TL. A combination of the load transistor TL and the amplification transistor Tb constructs a source follower, and the load transistor TL can be operated at a constant current.

In the column ADC circuit 4, capacitors C1 and C2, a comparator PA, switch transistors Tsw1 and Tsw2, an inverter V1, an up/down counter UD are provided in each column. An AND circuit N1 is provided in the up/down counter UD. In the line memory 5, a memory M is provided in each column.

The pixel signal output control unit 4a is provided in the column ADC circuit 4. A latch circuit RH, an inverter V2, and an OR circuit N2 are provided in the pixel signal output control unit 4a.

The vertical signal line Vlin is connected to an inverting input terminal of the comparator PA through the capacitor C1, and the ramp signal Vramp is input to a non-inverting input terminal of the comparator PA. The switch transistor Tsw1 is connected between the inverting input terminal and an output terminal of the comparator PA. The output terminal of the comparator PA is connected to an input terminal of the inverter V1 through the capacitor C2, and an output terminal of the inverter V1 is connected to one of input terminals of the OR circuit N2. The switch transistor Tsw2 is connected between the input terminal and the output terminal of the inverter V1. The output terminal of the inverter V1 is also connected to an input terminal of the inverter V2 through the latch circuit RH, and an output terminal of the inverter V2 is connected to the other input terminal of the OR circuit N2. An output terminal of the OR circuit N2 is connected to one of input terminals of the AND circuit N1, and a reference clock CKC is input to the other input terminal of the AND circuit N1. An output terminal of the up/down counter UD is connected to the memory M.

Level-shift transistors TBL1 and TBL2 are provided in the level-shift circuits 10-1 and 10-2, respectively. Drains of the level-shift transistors TBL1 and TBL2 are connected to the vertical signal line Vlin, and sources of the level-shift transistors TBL1 and TBL2 are grounded.

A switch SWBL and a variable voltage source VBL are provided in the level-shift control circuit 9. A terminal T1 of the switch SWBL is connected to gates of the level-shift transistors TBL1 and TBL2, a terminal T2 of the switch SWBL is connected to the variable voltage source VBL, and a terminal T3 of the switch SWBL is grounded.

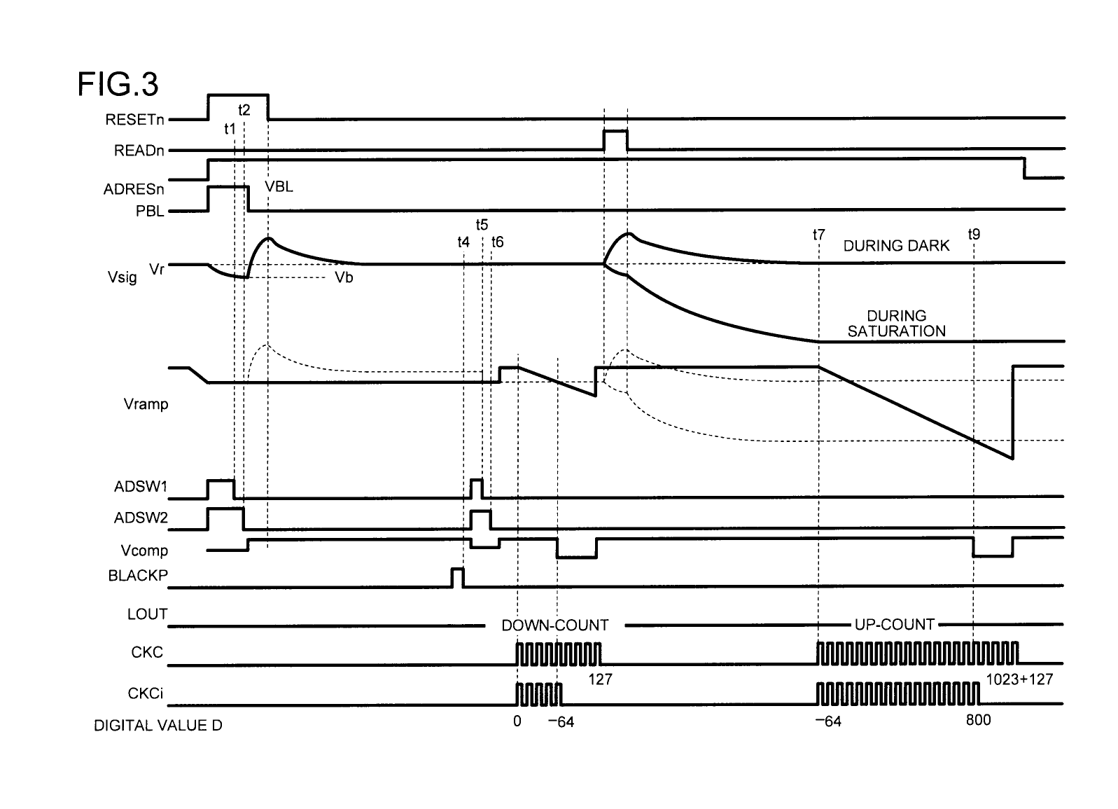

FIG. 3 is a timing chart illustrating an operation to read one pixel of the solid-state imaging device of FIG. 2. A thin dot line of the ramp signal Vramp indicates a level relationship with a signal waveform Vsig of an inverting input in the comparator operation of the comparator PA.

FIG. 3 is a timing chart illustrating the operation to read one pixel of the solid-state imaging device of FIG. 2 when the black dot is not generated.

Referring to FIG. 3, when the row selecting signal ADRESn is in a low level, the row selecting transistor Ta becomes an off-state, and the source follower operation is not performed. Therefore, the signal is not output to the vertical signal line Vlin. When the read signal READn and the reset signal RESETn become a high level, the read transistor Td is turned on, and the charges accumulated in the photodiode PD are discharged to the floating diffusion FD. The charges are discharged to the power supply VDD through the reset transistor Tc.

When the read signal READn becomes the low level after the charges accumulated in the photodiode PD are discharged to the power supply VDD, the accumulation of the effective signal charge is started in the photodiode PD.

When the row selecting signal ADRESn becomes the high level, the row selecting transistor Ta of the pixel PC is turned on, and the power supply potential VDD is applied to the drain of the amplification transistor Tb. Before the reset signal RESETn rises, a switching signal PBL is set to a ground potential by switching the switch SWBL to the terminal T3. The switching signal PBL is applied to the gates of the level-shift transistors TBL1 and TBL2 to turn off the level-shift transistors TBL1 and TBL2. Therefore, when the row selecting signal ADRESn becomes the high level, the source follower is constructed by the amplification transistor Tb and the load transistor TL.

When the reset signal RESETn rises, the reset transistor Tc is turned on, and the extra charge generated by a leak current is reset in the floating diffusion FD. The voltage corresponding to the reset level of the floating diffusion FD is applied to the gate of the amplification transistor Tb. Because the source follower is constructed by the amplification transistor Tb and the load transistor TL, the voltage at the vertical signal line Vlin follows the voltage applied to the gate of the amplification transistor Tb, and the output voltage Vsig of the reset level is output to the vertical signal line Vlin.

When the reset signal RESETn rises, the switch SWBL is switched onto the side of the terminal T2, and the variable voltage source VBL is connected to the terminal T1 of the switch SWBL, whereby the switching signal PBL rises. The switching signal PBL is applied to the level-shift transistors TBL1 and TBL2 to turn on the level-shift transistors TBL1 and TBL2, and the output voltage Vsig of the vertical signal line Vlin is shifted from a steady voltage Vr by a shift voltage Vb.

When a comparator zero setting pulse ADSW1 is applied to the gate of the switch transistor Tsw1 while the output voltage Vsig of the vertical signal line Vlin is shifted, the input voltage of the inverting input terminal of the comparator PA is clamped by the output voltage to set an operating point of the comparator PA.

When a comparator zero setting pulse ADSW2 is applied to the gate of the switch transistor Tsw2 while the output voltage Vsig of the vertical signal line Vlin is shifted, the input voltage of the input terminal of the inverter V1 is clamped by the output voltage to set an operating point of the inverter V1.

At this point, the charge corresponding to the shift voltage Vb is retained in the capacitors C1 and C2 while the output voltage Vsig of the vertical signal line Vlin is shifted, whereby the input voltages of the comparator PA and the inverter V1 are set to zero.

After the comparator zero setting pulses ADSW1 and ADSW2 fall (t1 and t2), the switch SWBL is switched to the terminal T3 to set the switching signal PBL to the ground potential. The switching signal PBL is applied to the gates of the level-shift transistors TBL1 and TBL2 to turn off the level-shift transistors TBL1 and TBL2, and the shift of the output voltage Vsig of the vertical signal line Vlin is released.

After the shift of the output voltage Vsig of the vertical signal line Vlin is released, the reset signal RESETn falls to turn off the reset transistor Tc. At this point, on the condition that the black dot is not generated, the output voltage Vsig converges to the steady voltage Vr, and the output voltage Vsig is maintained in the state higher than the ramp signal Vramp. Therefore, the output voltage of the comparator PA is maintained at the low level, and the output voltage of the comparator PA is inverted by the inverter V1, whereby an output voltage Vcomp of the inverter V1 is maintained at the high level.

After the reset signal RESETn falls, a black dot detection pulse BLACKP is input to the latch circuit RH to latch the level of the output voltage Vcomp, and the output voltage Vcomp is input to the OR circuit N2 through the inverter V2 (t4). At this point, because the output voltage Vcomp is maintained at the high level on the condition that the black dot is not generated, an output voltage LOUT of the inverter V2 is maintained at the low level, and the output voltage Vcomp of the inverter V1 is directly input to the up/down counter UD through the OR circuit N2.

When the black dot detection pulse BLACKP falls, in order to take in the correct reset level, the comparator zero setting pulse ADSW1 is applied to the gate of the switch transistor Tsw1 again (t5), and the comparator zero setting pulse ADSW2 is applied to the gate of the switch transistor Tsw2 again (t6).

After the comparator zero setting pulses ADSW1 and ADSW2 fall, a triangular wave is provided as the ramp signal Vramp while the output voltage Vsig of the reset level is input to the comparator PA through the capacitor C1, and the output voltage Vsig of the reset level and the ramp signal Vramp are compared to each other. The output voltage of the comparator PA is inverted by the inverter V1, and the output voltage Vcomp of the inverter V1 is input to one of the input terminals of the AND circuit N1 through the OR circuit N2.

The reference clock CKC is input to the other input terminal of the AND circuit N1. When the output voltage Vsig of the reset level is lower than the level of the ramp signal Vramp, the output voltage Vcomp becomes the high level. Therefore, the reference clock CKC passes through the AND circuit N1, and a reference clock CKCi of the post-passage is down-counted by the up/down counter UD.

When the output voltage Vsig of the reset level is matched with the level of the ramp signal Vramp, the output voltage of the comparator PA falls, and the output voltage Vcomp becomes the low level. The reference clock CKC is blocked by the AND circuit N1, and the down-count is stopped by the up/down counter UD1. Therefore, the output voltage Vsig of the reset level is converted into a digital value D, and the digital value D is retained in the up/down counter UD.

When the read signal READn rises, the read transistor Td is turned on, the charges accumulated in the photodiode PD are transferred to the floating diffusion FD, and the voltage corresponding to the signal level of the floating diffusion FD is applied to the gate of the amplification transistor Tb. Because the source follower is constructed by the amplification transistor Tb and the load transistor TL, the voltage at the vertical signal line Vlin follows the voltage applied to the gate of the amplification transistor Tb to be output to the vertical signal line Vlin as the output voltage Vsig of the read level.

The triangular wave is provided as the ramp signal Vramp while the output voltage Vsig of the read level is input to the comparator PA through the capacitor C1, and the output voltage Vsig of the read level and the ramp signal Vramp are compared to each other (t7). The output voltage of the comparator PA is inverted by the inverter V1, and the output voltage Vcomp of the inverter V1 is input to one of the input terminals of the AND circuit N1 through the OR circuit N2.

When the output voltage Vsig of the read level is lower than the level of the ramp signal Vramp, the output voltage Vcomp becomes the high level. Therefore, the reference clock CKC passes through the AND circuit N1, and the reference clock CKCi of the post-passage is up-counted by the up/down counter UD. When the output voltage Vsig of the read level is matched with the level of the ramp signal Vramp, the output voltage of the comparator PA falls, and the output voltage Vcomp becomes the low level. The reference clock CKC is blocked by the AND circuit N1, and the up-count is stopped by the up/down counter UD. Therefore, a difference between the output voltage Vsig of the read level and the output voltage Vsig of the reset level is converted into the digital value D, and the digital value D is transmitted to the line memory M (t9).

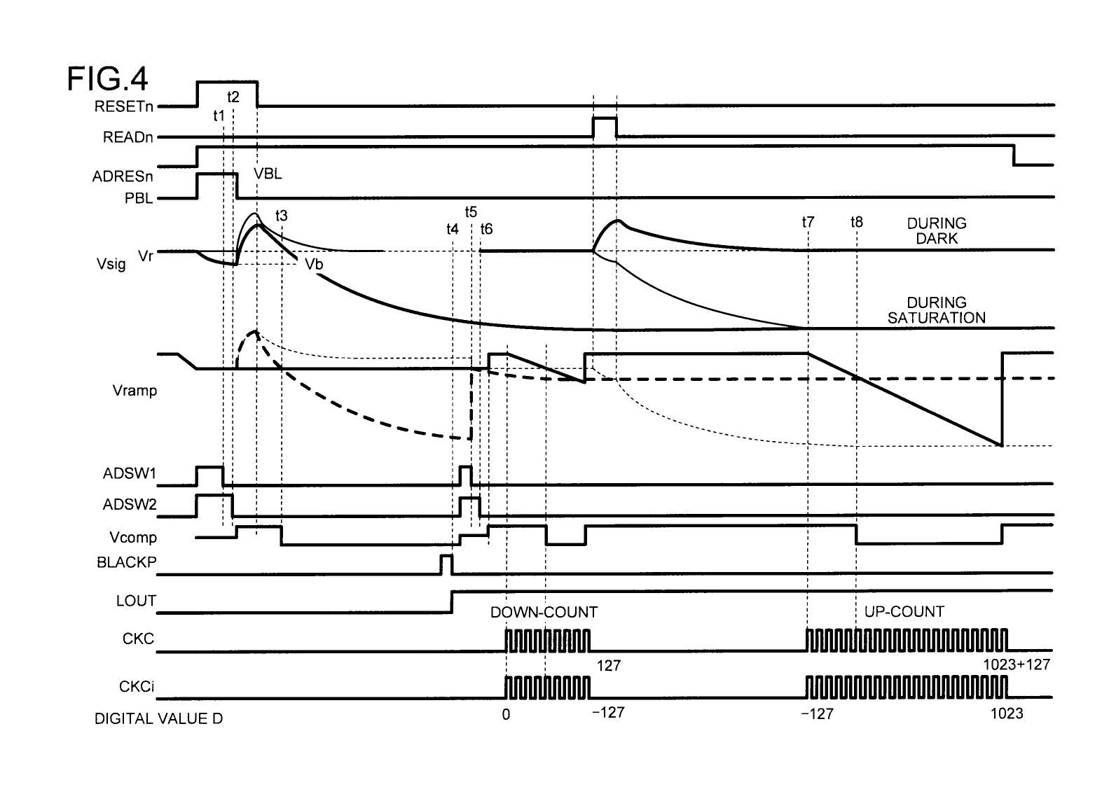

FIG. 4 is a timing chart illustrating the operation to read one pixel of the solid-state imaging device of FIG. 2 when the black dot is generated.

Referring to FIG. 4, on the condition that the black dot is not generated, when the reset signal RESETn falls, the output voltage Vsig converges to the steady voltage Vr, and the output voltage Vsig is maintained in the state higher than the ramp signal Vramp.

On the other hand, on the condition that the black dot is generated, when the reset signal RESETn falls, the output voltage Vsig becomes lower than the steady voltage Vr, and a change in potential from the steady voltage Vr becomes equal to or higher than the shift voltage Vb.

Therefore, the output voltage of the comparator PA becomes the high level, and the output voltage of the comparator PA is inverted by the inverter V1, whereby the output voltage Vcomp of the inverter V1 becomes the low level (t3). Even if the potential at the vertical signal line Vlin varies by the generation of the change in potential at the detection unit, which is caused by a process variation or a power supply fluctuation, the shift voltage Vb can substantially be kept constant. The shift voltage Vb can be set by the voltage at the variable voltage source VBL, which is applied to the level-shift transistors TBL1 and TBL2.

After the reset signal RESETn falls, the black dot detection pulse BLACKP is input to the latch circuit RH to latch the level of the output voltage Vcomp, and the output voltage Vcomp is input to the OR circuit N2 through the inverter V2 (t4). At this point, because the output voltage Vcomp is maintained at the low level on the condition that the black dot is generated, the output voltage LOUT of the inverter V2 is maintained at the high level, and the output voltage of the OR circuit N2 becomes the high level irrespective of the output voltage Vcomp of the inverter V1. One of the input terminals of the AND circuit N1 is always maintained at the high level, the reference clock CKC passes directly through the AND circuit N1, and the reference clock CKCi of the post-passage is down-counted by the up/down counter UD. Therefore, the output voltage Vsig of the reset level is converted into the digital value D of the maximum value of −127 of the down-count, and the digital value D is retained in the up/down counter UD.

When the read signal READn rises, the read transistor Td is turned on, the charges accumulated in the photodiode PD are transferred to the floating diffusion FD, and the voltage corresponding to the signal level of the floating diffusion FD is applied to the gate of the amplification transistor Tb. Because the source follower is constructed by the amplification transistor Tb and the load transistor TL, the voltage at the vertical signal line Vlin follows the voltage applied to the gate of the amplification transistor Tb to be output to the vertical signal line Vlin as the output voltage Vsig of the read level.

At this point, on the condition that the black dot is generated, the output voltage LOUT of the inverter V2 is maintained at the high level by the latch circuit RH, and the output voltage of the OR circuit N2 becomes the high level irrespective of the output voltage Vcomp of the inverter V1. One of the input terminals of the AND circuit N1 is always maintained at the high level, the reference clock CKC passes directly through the AND circuit N1, and the reference clock CKCi of the post-passage is up-counted by the up/down counter UD. Therefore, the up-count operation is performed from the reset level of −127, and the digital value D is up-counted to the saturation signal level of 1023. The saturation signal level of 1023 is converted into the digital value D, and the digital value D is transmitted to the line memory M.

On the condition that the black dot is generated, the digital value D can generate the saturation signal level of 1023 by the count operation of the reference clock CKC, and the saturation signal can be output as the pixel signal.

The black dot detection condition can be set based on the output voltage Vsig of the vertical signal line Vlin shifted by the level-shift circuits 10-1 and 10-2, the variation in potential at the vertical signal line Vlin during the reset can be taken in the black dot detection condition. As a result, the need to wait for a long time until the potential at the vertical signal line Vlin is excessively changed is eliminated in order to be able to securely detect the generation of the black dot, so that the time necessary to detect the generation of the black dot can be shortened. For example, the operation can be performed while the detection time t4 is considerably brought close to the time t3.

In the example of FIG. 1, the level-shift circuits 10-1 and 10-2 are vertically provided at both ends of the pixel array unit 1-1. Alternatively, the level-shift circuits 10-1 and 10-2 may vertically be provided only at one end of the pixel array unit 1-1.

### Second Embodiment

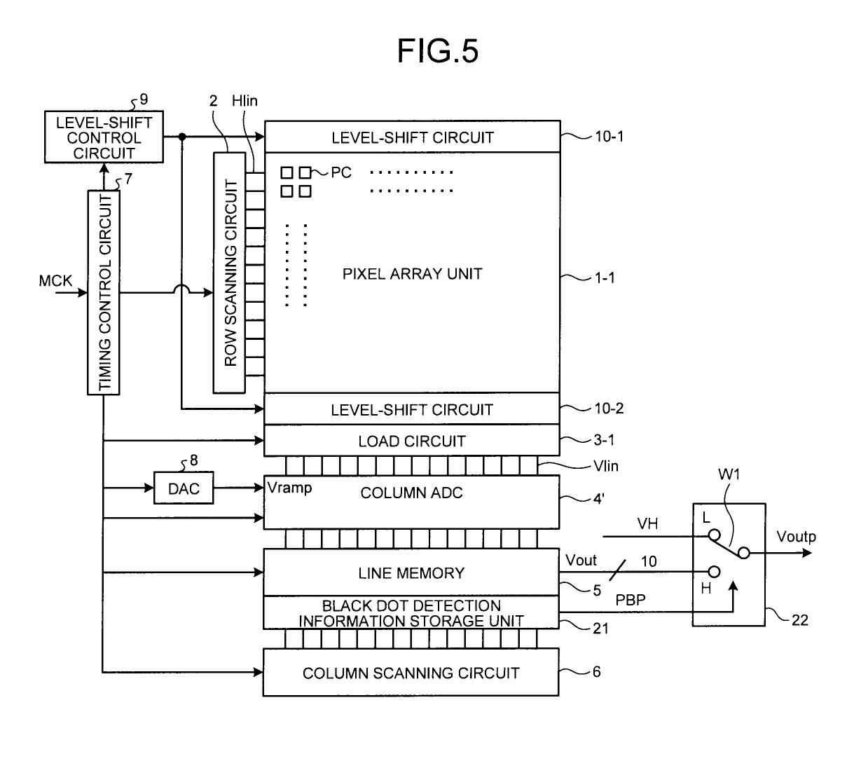

FIG. 5 is a block diagram illustrating a schematic configuration of a solid-state imaging device according to a second embodiment.

Referring to FIG. 5, in the solid-state imaging device, a column ADC circuit 4′ is provided instead of the column ADC circuit 4 of the solid-state imaging device of FIG. 1, and a black dot detection information storage unit 21 and a pixel signal switching unit 22 are provided. In the column ADC circuit 4′, the pixel signal output control unit 4a is removed from the column ADC circuit 4. The black dot detection information storage unit 21 can store black dot detection information PBP based on the change in potential at the vertical signal line Vlin when the potential at the vertical signal line Vlin shifted by the level-shift circuits 10-1 and 10-2 is used as the reference. The pixel signal switching unit 22 can switch the output of the pixel signal based on the black dot detection information PBP stored in the black dot detection information storage unit 21. A switch W1 that switches between the output signal Vout and a saturation output VH based on the black dot detection information PBP is provided in the pixel signal switching unit 22.

The level-shift circuits 10-1 and 10-2 shift the potential at the vertical signal line Vlin when the reset signal is read from the pixel PC. After the shift of the potential at the vertical signal line Vlin is released, when the change in potential at the vertical signal line Vlin becomes equal to or higher than the shift amount of the potential at the vertical signal line Vlin, the black dot detection information PBP is stored in the black dot detection information storage unit 21.

In the pixel signal switching unit 22, the output signal Vout is output as a correction output Voutp when the black dot detection information PBP is not stored, and the saturation output VH is output as the correction output Voutp when the black dot detection information PBP is stored.

Therefore, the need to provide the pixel signal output control unit 4a of FIG. 1 in each column is eliminated, and the black dot can be detected and corrected while a circuit scale is reduced compared with the configuration of FIG. 1.

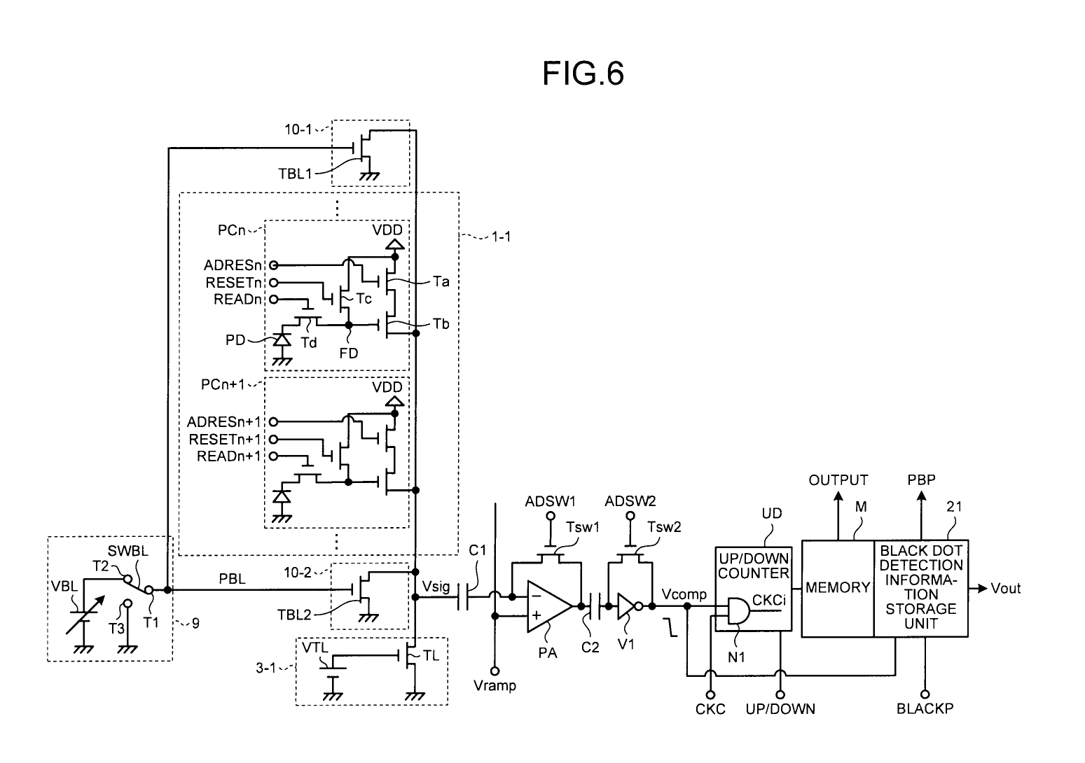

FIG. 6 is a circuit diagram illustrating a schematic configuration of one column of the solid-state imaging device of FIG. 5.

Referring to FIG. 6, in the solid-state imaging device, the pixel signal output control unit 4a is removed from the column ADC circuit 4, and the black dot detection information storage unit 21 is provided.

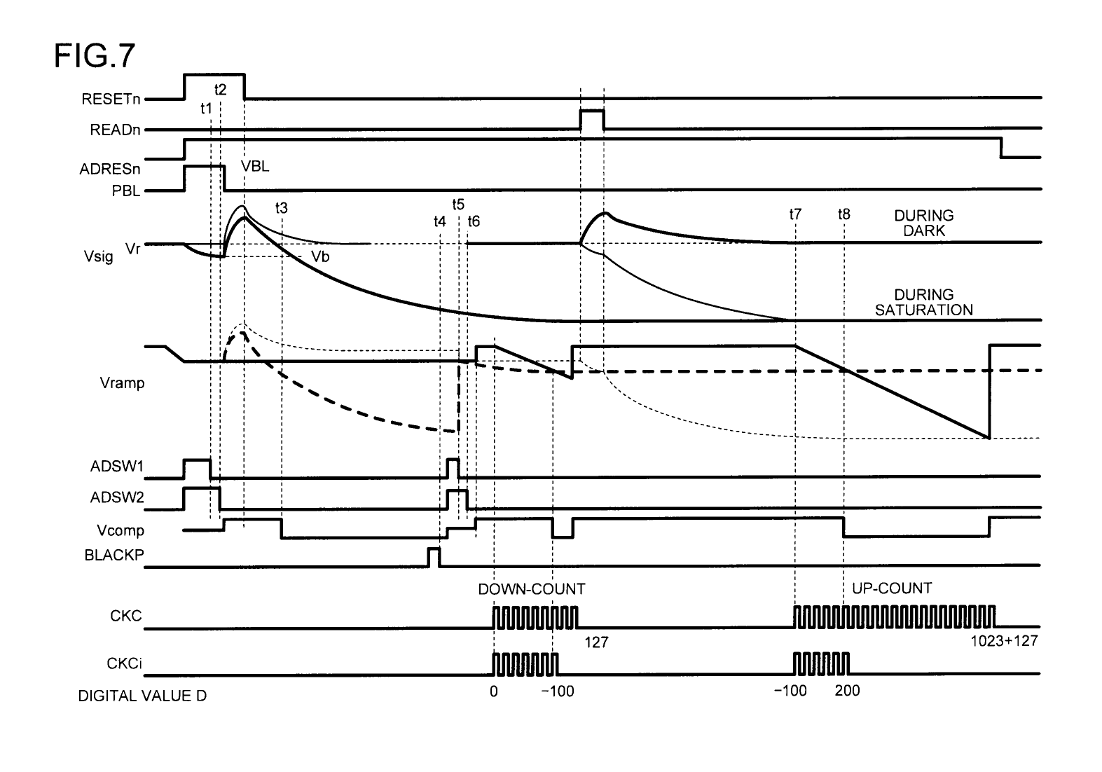

FIG. 7 is a timing chart illustrating the operation to read one pixel of the solid-state imaging device of FIG. 6 when the black dot is generated.

Referring to FIG. 7, in the solid-state imaging device of FIG. 2, on the condition that the black dot is generated, the black dot detection pulse BLACKP is input to the latch circuit RH, whereby the level of the output voltage Vcomp is latched by the latch circuit RH.

On the other hand, in the solid-state imaging device of FIG. 6, on the condition that the black dot is generated, the black dot detection pulse BLACKP is input to the black dot detection information storage unit 21, whereby an LO level is stored as the black dot detection information PBP.

After the comparator zero setting pulses ADSW1 and ADSW2 fall (T5 and T6), the triangular wave is provided as the ramp signal Vramp while the output voltage Vsig of the reset level is input to the comparator PA through the capacitor C1, and the output voltage Vsig of the reset level and the ramp signal Vramp are compared to each other. The output voltage of the comparator PA is inverted by the inverter V1, and the output voltage Vcomp of the inverter V1 is input to one of the input terminals of the AND circuit N1.

The reference clock CKC is input to the other input terminal of the AND circuit N1. When the output voltage Vsig of the reset level is lower than the level of the ramp signal Vramp, the output voltage Vcomp becomes the high level. Therefore, the reference clock CKC passes through the AND circuit N1, and the reference clock CKCi of the post-passage is down-counted by the up/down counter UD.

When the output voltage Vsig of the reset level is matched with the level of the ramp signal Vramp, the output voltage of the comparator PA rises, and the output voltage Vcomp becomes the low level. The reference clock CKC is blocked by the AND circuit N1, and the down-count is stopped by the up/down counter UD. Therefore, the output voltage Vsig of the reset level is converted into a digital value D, and the digital value D is retained in the up/down counter UD. For example, the digital value D becomes −100.

When the read signal READn rises, the read transistor Td is turned on, the charges accumulated in the photodiode PD are transferred to the floating diffusion FD, and the voltage corresponding to the signal level of the floating diffusion FD is applied to the gate of the amplification transistor Tb. Because the source follower is constructed by the amplification transistor Tb and the load transistor TL, the voltage at the vertical signal line Vlin follows the voltage applied to the gate of the amplification transistor Tb to be output to the vertical signal line Vlin as the output voltage Vsig of the read level.

The triangular wave is provided as the ramp signal Vramp while the output voltage Vsig of the read level is input to the comparator PA through the capacitor C1, and the output voltage Vsig of the read level and the ramp signal Vramp are compared to each other. The output voltage of the comparator PA is inverted by the inverter V1, and the output voltage Vcomp of the inverter V1 is input to one of the input terminals of the AND circuit N1.

When the output voltage Vsig of the read level is lower than the level of the ramp signal Vramp, the output voltage Vcomp becomes the high level. Therefore, the reference clock CKC passes through the AND circuit N1, and the reference clock CKCi of the post-passage is up-counted by the up/down counter UD. When the output voltage Vsig of the read level is matched with the level of the ramp signal Vramp, the output voltage of the comparator PA rises, and the output voltage Vcomp becomes the low level. The reference clock CKC is blocked by the AND circuit N1, and the up-count is stopped by the up/down counter UD. Therefore, a difference between the output voltage Vsig of the read level and the output voltage Vsig of the reset level is converted into the digital value D, and the digital value D is transmitted to the memory M. For example, the digital value D is up-counted from −100 and becomes 200. Although the digital value D ought to be the saturation signal in this state, the digital value does not become the saturation signal, and the black level is generated.

At this point, the black dot can be corrected by providing the pixel signal switching unit 22 of FIG. 5, even if the up/down counter UD is operated based on the output voltage Vsig. Because the switch W1 becomes the L side by the data LO of the black dot detection information storage unit 21, the previous digital value D of 200 of the signal can be output while switched to the saturation signal of 1023.

Similarly to the first embodiment, the generation of the black dot is accurately detected in a short period of time, and the digital value D can be corrected to the saturation signal level.

### Third Embodiment

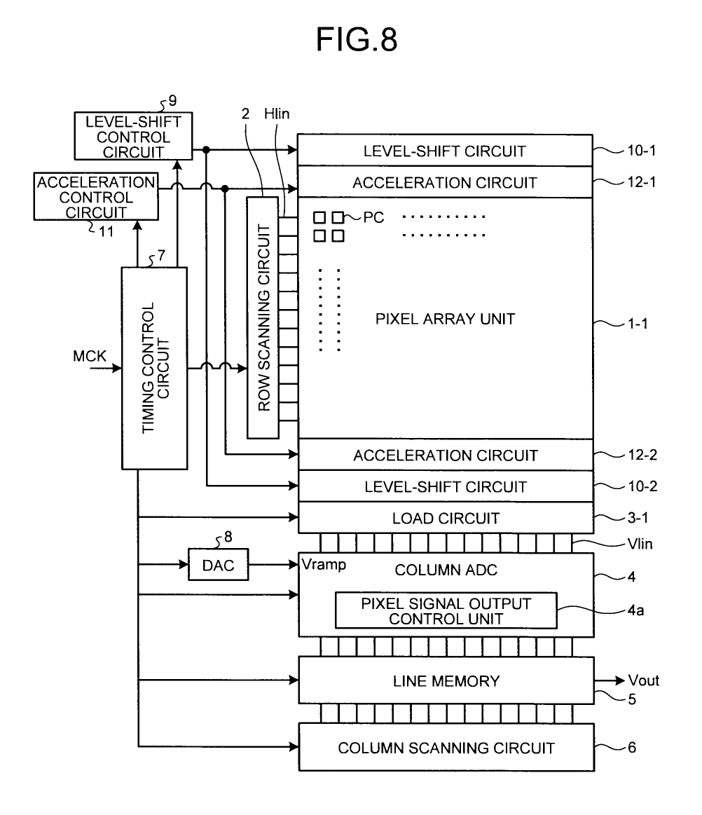

FIG. 8 is a block diagram illustrating a schematic configuration of a solid-state imaging device according to a third embodiment.

Referring to FIG. 8, in the solid-state imaging device, acceleration circuits 12-1 and 12-2 and an acceleration control circuit 11 are added to the configuration of FIG. 1. The acceleration circuits 12-1 and 12-2 can previously shift the potential at the vertical signal line Vlin before the signal is read from the pixel PC. The acceleration control circuit 11 can control the time the potential at the vertical signal line Vlin is previously shifted. Specifically, the acceleration control circuit 11 can previously shift the potential at the vertical signal line Vlin, when or immediately before the reset operation of the pixel PC is performed, or when or immediately before the read operation of the pixel PC is performed.

The row scanning circuit 2 vertically scans the pixels PC to select the pixels PC in the row direction, and the signals read from the pixels PC are transmitted to the column ADC circuit 4 through the vertical signal line Vlin. When the signal is read from the pixel PC, the acceleration circuits 12-1 and 12-2 previously shift the potential at the vertical signal line Vlin in a direction in which the potential at the vertical signal line Vlin is shifted.

In the column ADC circuit 4, the reset level and the read level are sampled from the signals of the pixels PC, the signal component of each pixel PC is digitized with the CDS by calculating the difference between the reset level and the read level, and the digitized signal component is output as the output signal Vout through the line memory 5.

When the signal is read from the pixel PC, the time necessary for the potential at the vertical signal line Vlin to converge to the reset level or the read level can be shortened by previously shifting the potential at the vertical signal line Vlin. Therefore, a responsive property of the vertical signal line Vlin through which the signal read from the pixel PC is transmitted can be improved, and speed enhancement of the solid-state imaging device can be achieved during the read.

The level-shift circuits 10-1 and 10-2 shift the potential at the vertical signal line Vlin when the reset signal is read from the pixel PC. The pixel signal output control unit 4a controls the column ADC circuit 4 such that the saturation signal is output as the output signal Vout when the amount of change in potential at the vertical signal line Vlin becomes equal to or higher than the shift amount of the potential at the vertical signal line Vlin after the shift of the potential at the vertical signal line Vlin is released.

Therefore, the change in potential at the vertical signal line Vlin can be monitored based on the potential at the vertical signal line Vlin, which is shifted during the reset. Even if the potential at the vertical signal line Vlin varies during the reset, the incidence of the excessive light can be detected from the potential at the vertical signal line Vlin without ensuring the margin for the variation in potential. As a result, the need to wait for a long time until the potential at the vertical signal line Vlin is excessively changed during the reset is eliminated in order to be able to securely detect the generation of the black dot, so that the time necessary to detect the generation of the black dot can be shortened.

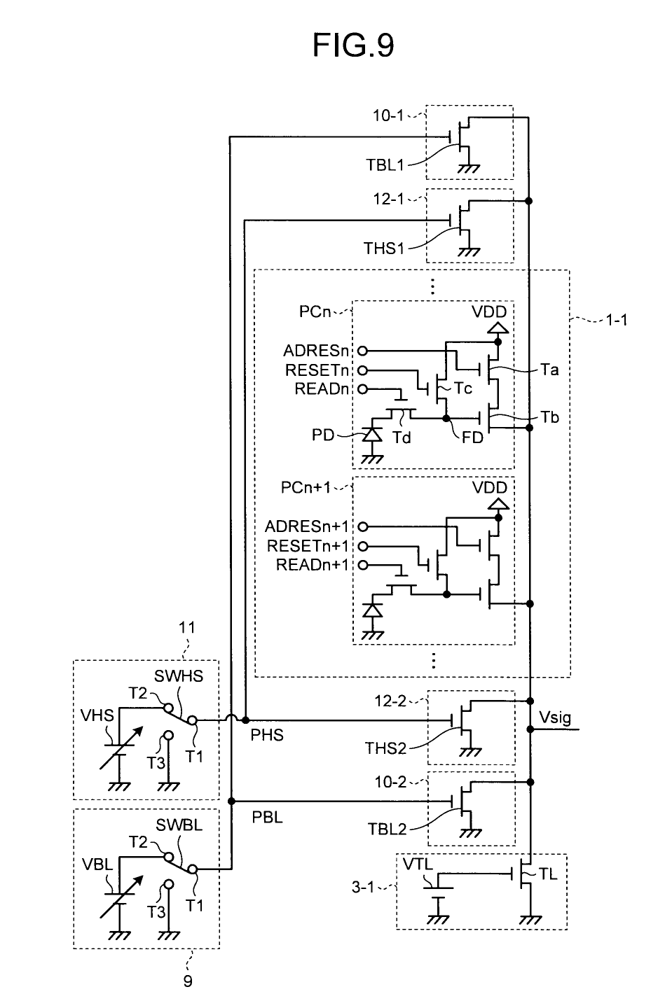

FIG. 9 is a circuit diagram illustrating a schematic configuration of one column of the solid-state imaging device of FIG. 8.

Referring to FIG. 9, in the solid-state imaging device, the acceleration circuits 12-1 and 12-2 and the acceleration control circuit 11 are added to the configuration of FIG. 2.

Acceleration transistors THS1 and THS2 are provided in the acceleration circuits 12-1 and 12-2, respectively. Drains of the acceleration transistors THS1 and THS2 are connected to the vertical signal line Vlin, and sources of the acceleration transistors THS1 and THS2 are grounded.

A switch SWHS and a variable voltage source VHS are provided in the acceleration control circuit 11. The terminal T1 of the switch SWHS is connected to gates of the acceleration transistors THS1 and THS2, the terminal T2 of the switch SWHS is connected to the variable voltage source VHS, and the terminal T3 of the switch SWHS is grounded.

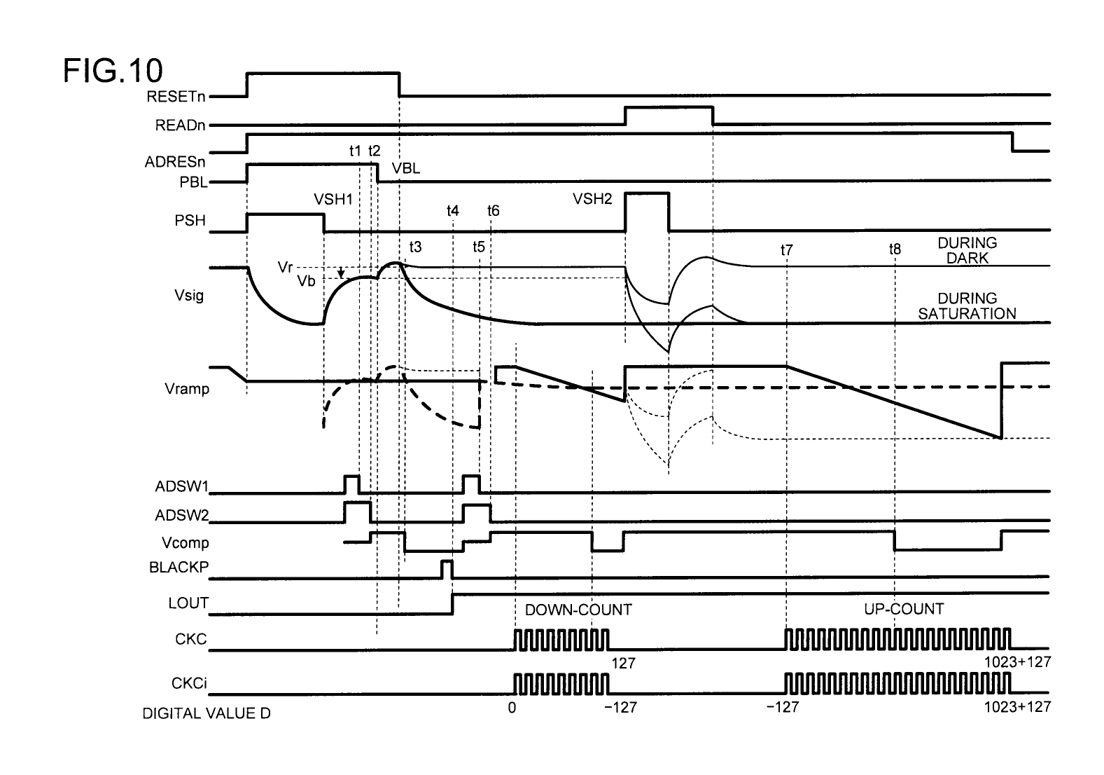

FIG. 10 is a timing chart illustrating the operation to read one pixel of the solid-state imaging device of FIG. 9 when the black dot is generated.

Referring to FIG. 10, the operation of the solid-state imaging device of FIG. 9 is identical to the operation of FIG. 4 except that an acceleration pulse PHS is applied to the gates of the acceleration transistors THS1 and THS2 to reduce the potential at the vertical signal line Vlin during the reset operation and the signal read operation.

That is, the switch SWHS is switched from the terminal T3 to the terminal T2 during the reset operation while the row selecting signals ADRESn is in the high-level state, whereby the acceleration pulse PHS is applied to the gates of the acceleration transistors THS1 and THS2 to turn on the acceleration transistors THS1 and THS2.

When the acceleration transistors THS1 and THS2 are turned on, the potential at the vertical signal line Vlin is drawn to the ground level and the potential at the vertical signal line Vlin is reduced.

When the reset signal RESETn rises while the potential at the vertical signal line Vlin is reduced, the reset transistor Tc is turned on, and the extra charge generated by the leak current or the like is reset in the floating diffusion FD. The voltage corresponding to the reset level of the floating diffusion FD is applied to the gate of the amplification transistor Tb, and the output voltage Vsig of the reset level is output to the vertical signal line Vlin.

When the signal read operation is performed while the row selecting transistor Ta of the pixel PC is in the on-state, the switch SWHS is switched from the terminal T3 to the terminal T2 to apply the acceleration pulse PHS to the gates of the acceleration transistors THS1 and THS2, and the acceleration transistors THS1 and THS2 are turned on.

When the acceleration transistors THS1 and THS2 are turned on, the potential at the vertical signal line Vlin is drawn to the ground level, and the potential at the vertical signal line Vlin is reduced.

When the read signal READn rises while the potential at the vertical signal line Vlin is reduced, the read transistor Td is turned on, and the charge accumulated in the photodiode PD is transferred to the floating diffusion FD. The voltage corresponding to the signal level of the floating diffusion FD is applied to the gate of the amplification transistor Tb, and output as the output voltage Vsig of the read level to the vertical signal line Vlin.

A voltage VHS1 of the acceleration pulse PHS is set so as to reduce the level of the vertical signal line Vlin, which is changed when the reset signal RESETn rises, so that the potential at the vertical signal line Vlin can be stabilized immediately after the reset operation to improve the responsive property of the vertical signal line Vlin. For example, in an 800-million-pixel CMOS image sensor having a pixel size of 1.4 um, when the acceleration pulse PHS is applied during the reset operation, the responsive property of the vertical signal line Vlin can be shortened to 0.2 uS of about ¼ compared with the case in which the acceleration pulse PHS is not applied.

A voltage VSH2 of the acceleration pulse PHS, which is applied during the signal read operation, is set such that the potential at the vertical signal line Vlin becomes an intermediate level of the dark signal level and the saturation signal level, so that a charge amount of the vertical signal line Vlin can be set to about ½, and the response time of the vertical signal line Vlin can be shortened to 0.4 uS of about ½. The high-speed operation can be implemented by improving both the time necessary to detect the black dot and the responsive property of the vertical signal line.

In the dark environment, amplitude of the ramp signal Vramp is decreased to rise an analog gain, and an effective saturation signal amount of the photodiode PD is decreased. At this point, the responsive property of the vertical signal line Vlin can further be improved by changing the voltage VHS2 of the acceleration pulse PHS according to the saturation signal level. At the same time, 1/f (RTS) noise can further be reduced by putting ahead the starting time of the second-time ADC operation.

In the example of FIG. 9, the acceleration circuits 12-1 and 12-2 are vertically provided at both ends of the pixel array unit 1-1. Alternatively, the acceleration circuits 12-1 and 12-2 may vertically be provided only at one end of the pixel array unit 1-1.

### Fourth Embodiment

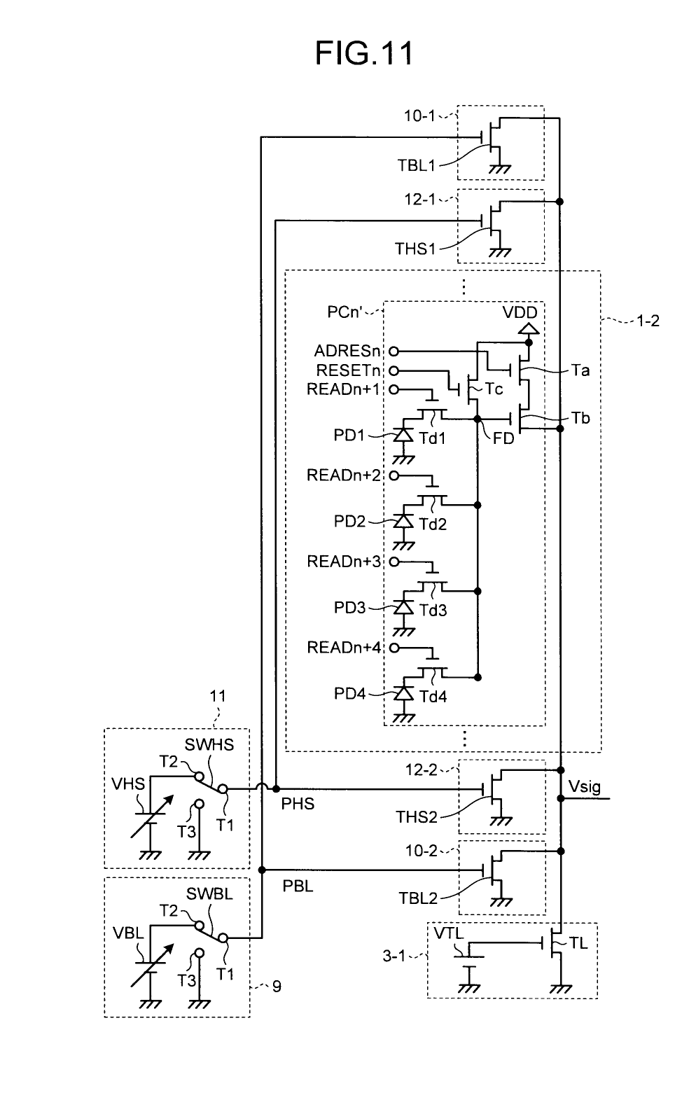

FIG. 11 is a circuit diagram illustrating a schematic configuration of one column of a solid-state imaging device according to a fourth embodiment.

Referring to FIG. 11, in the solid-state imaging device, a pixel array unit 1-2 is provided instead of the pixel array unit 1-1 of FIG. 2. In the pixel array unit 1-2, a pixel PCn′ is provided instead of the pixel PCn.

In the pixel PCn′, read transistors Td1 to Td4 are provided instead of the read transistor Td, and photodiodes PD1 to PD4 are provided instead of the photodiode PD.

The photodiodes PD1 to PD4 are connected to the read transistors Td1 to Td4, respectively, and the one amplification transistor Tb is shared by the four photodiodes PD1 to PD4.

When the amplification transistor Tb is shared by the plural pixels, the number of amplification transistors Tb connected to the vertical signal line Vlin can be decreased to reduce a load capacitance of the vertical signal line Vlin, so that the responsive property can be improved.

In the example of FIG. 11, the one amplification transistor Tb is shared by the four pixels. Alternatively, the one amplification transistor Tb may be shared by the arbitrary number of pixels.

### Fifth Embodiment

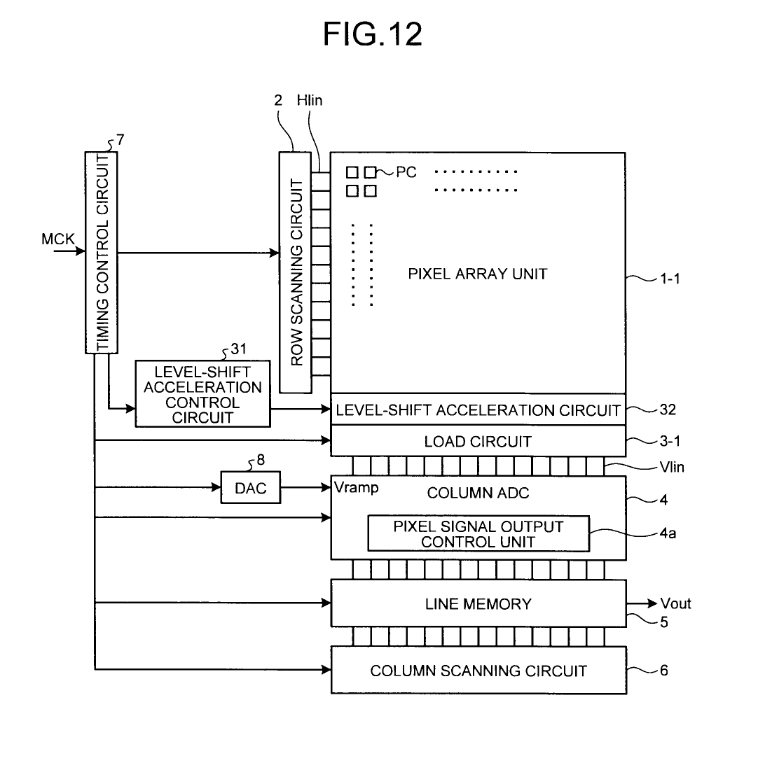

FIG. 12 is a block diagram illustrating a schematic configuration of a solid-state imaging device according to a fifth embodiment.

Referring to FIG. 12, in the solid-state imaging device, a level-shift acceleration circuit 32 and a level-shift acceleration control circuit 31 are provided instead of the level-shift circuits 10-1 and 10-2 and the level-shift control circuit 9 of the solid-state imaging device of FIG. 1.

The level-shift acceleration circuit 32 can shift the potential at the vertical signal line Vlin to at least two stages. The shift in the first stage of the level-shift acceleration circuit 32 can correspond to the shift performed by the level-shift circuits 10-1 and 10-2 of FIG. 8, and the shift in the second stage of the level-shift acceleration circuit 32 can correspond to the shift performed by the acceleration circuits 12-1 and 12-2 of FIG. 8.

The level-shift acceleration control circuit 31 can control the amount of shifted potential at the vertical signal line Vlin.

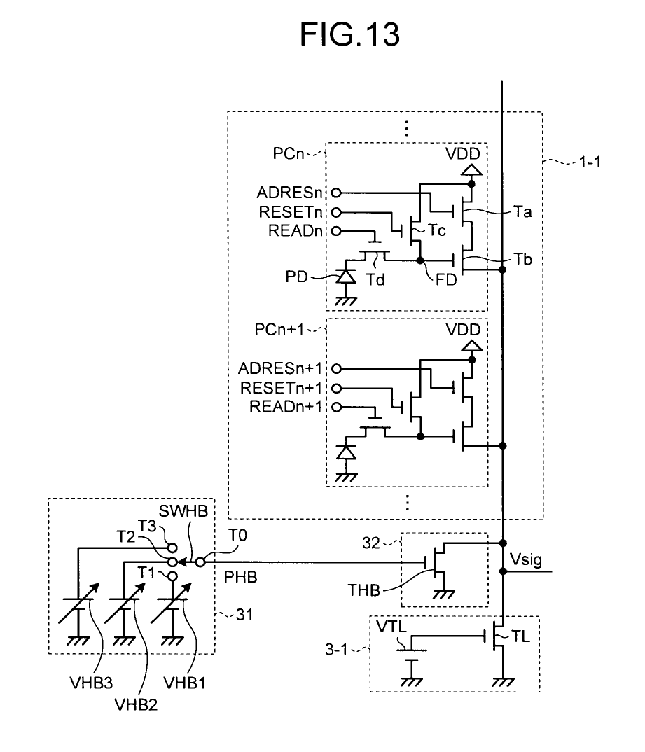

FIG. 13 is a circuit diagram illustrating a schematic configuration of one column of the solid-state imaging device of FIG. 12.

Referring to FIG. 13, in the solid-state imaging device, the level-shift acceleration circuit 32 and the level-shift acceleration control circuit 31 are provided instead of the level-shift circuits 10-1 and 10-2 and the level-shift control circuit 9 of the solid-state imaging device of FIG. 2.

A level-shift acceleration transistor THB is provided in the level-shift acceleration circuit 32. A drain of the level-shift acceleration transistor THB is connected to the vertical signal line Vlin, and a source of the level-shift acceleration transistor THB is grounded. A gate of the level-shift acceleration transistor THB is connected to a terminal T0 of a switch SWHB.

The switch SWHB and variable voltage sources VHB1 to VHB3 are provided in the level-shift acceleration control circuit 31. The terminal T0 of the switch SWHB is connected to the gate of the level-shift acceleration transistor THB, the terminal T1 of the switch SWHB is connected to the variable voltage source VHB1, the terminal T2 of the switch SWHB is connected to the variable voltage source VHB2, and the terminal T3 of the switch SWHB is connected to the variable voltage source VHB3. The voltages at the variable voltage sources VHB1 to VHB3 can be set to VHB1<VHB2<VHB3.

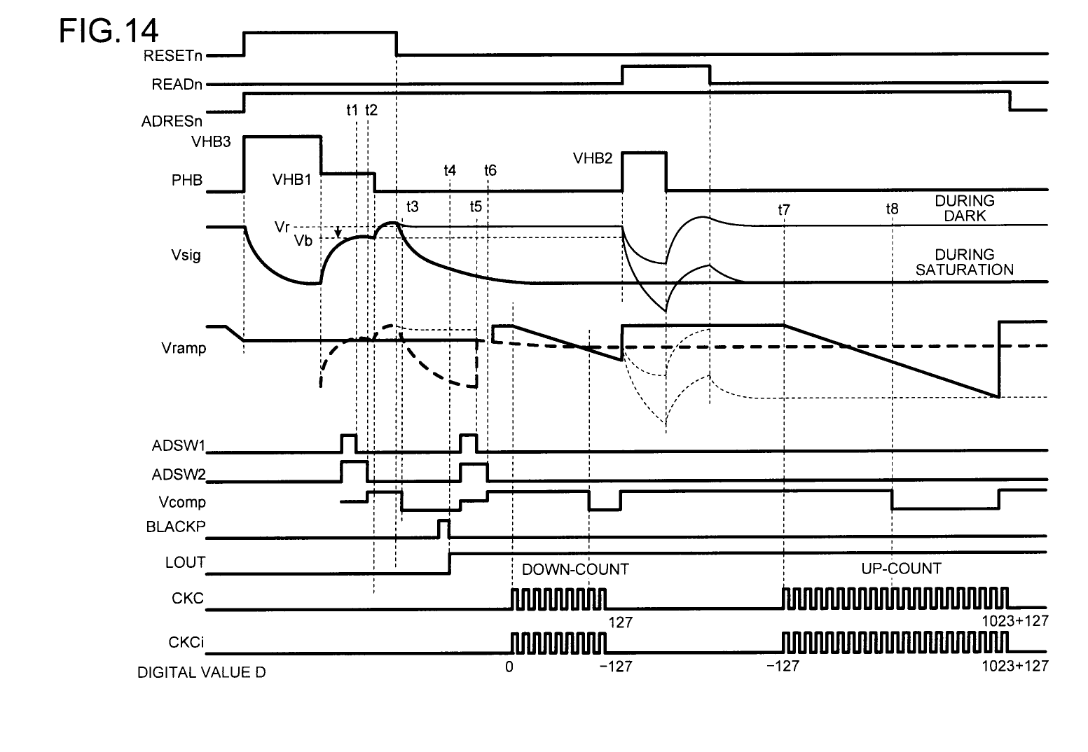

FIG. 14 is a timing chart illustrating the operation to read one pixel of the solid-state imaging device of FIG. 13 when the black dot is generated.

Referring to FIG. 14, when the switch SWHB is witched to the terminal T3 while the selecting signal ADRESn is in the high-level state, the level of the switching signal PHB is set to VHB3 and applied to the gate of the level-shift acceleration transistor THB.

When the gate potential at the level-shift acceleration transistor THB is set to VHB3, the potential at the vertical signal line Vlin is drawn to the ground level, and the potential at the vertical signal line Vlin is reduced.

When the reset signal RESETn rises while the potential at the vertical signal line Vlin is reduced, the reset transistor Tc is turned on, and the extra charge generated by the leak current or the like is reset in the floating diffusion FD. The voltage corresponding to the reset level of the floating diffusion FD is applied to the gate of the amplification transistor Tb, and the output voltage Vsig of the reset level is output to the vertical signal line Vlin.

The switch SWHB is switched to the terminal T1 while the output voltage Vsig of the reset level is output to the vertical signal line Vlin, whereby the level of the switching signal PHb is set to VHB1 and applied to the gate of the level-shift acceleration transistor THB.

When the gate potential at the level-shift acceleration transistor THB is set to VHB1, the output voltage Vsig of the vertical signal line Vlin is shifted from the steady voltage Vr by the shift voltage Vb. At this point, the operating point of the comparator PA is set by applying the comparator zero setting pulse ADSW1 to the gate of the switch transistor Tsw1, and the operating point of the inverter V1 is set by applying the comparator zero setting pulse ADSW2 to the gate of the switch transistor Tsw2.

At this point, the charge corresponding to the shift voltage Vb is retained in the capacitors C1 and C2 while the output voltage Vsig of the vertical signal line Vlin is shifted, whereby the voltages of the comparator PA and the inverter V1 are set to zero.

When the signal read operation is performed while the row selecting transistor Ta of the pixel PCn is in the on-state, the switch SWHS is switched to the terminal T2, whereby the level of the switching signal PHB is set to VHB2 and applied to the gate of the level-shift acceleration transistor THB.

When the gate potential at the level-shift acceleration transistor THB is set to VHB2, the potential at the vertical signal line Vlin is drawn to the ground level, and the potential at the vertical signal line Vlin is reduced.

When the read signal READn rises while the potential at the vertical signal line Vlin is reduced, the read transistor Td is turned on, and the charge accumulated in the photodiode PD is transferred to the floating diffusion FD. The voltage corresponding to the signal level of the floating diffusion FD is applied to the gate of the amplification transistor Tb, and output as the output voltage Vsig of the read level to the vertical signal line Vlin.

The level-shift operation and the acceleration operation can be performed by one level-shift acceleration transistor THB by shifting the gate potential at the level-shift acceleration transistor THB to three stages, and the black dot detection time the responsive property of the vertical signal line can be improved similarly to the case of FIG. 10. The circuit scale can be reduced compared with the configuration of FIG. 9.

### Sixth Embodiment

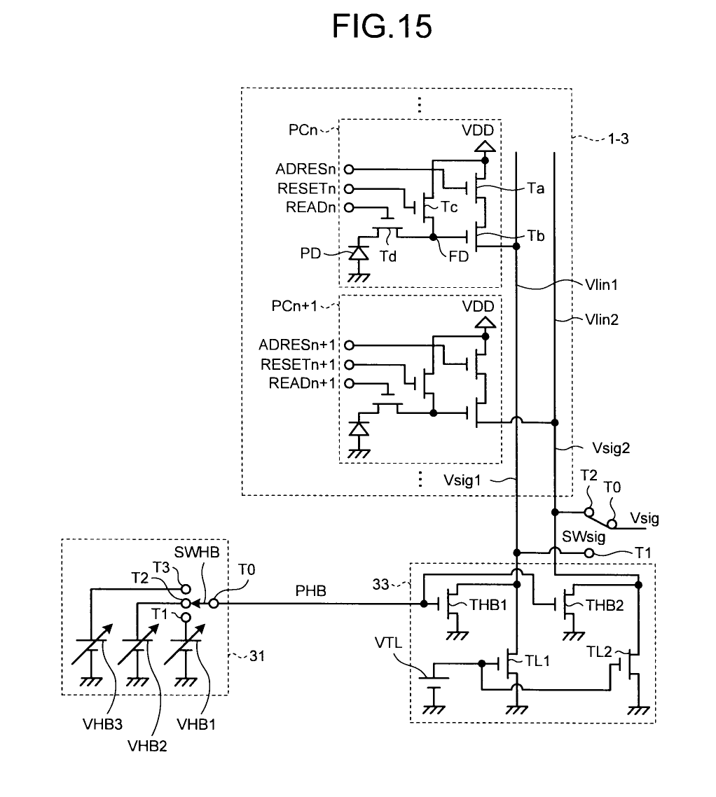

FIG. 15 is a circuit diagram illustrating a schematic configuration of one column of a solid-state imaging device according to a sixth embodiment.

Referring to FIG. 15, in the solid-state imaging device, a pixel array unit 1-3 and a level-shift acceleration load circuit 33 are provided instead of the pixel array unit 1-1, the load circuit 3-1, and the level-shift acceleration circuit 32 of FIG. 13.

In the pixel array unit 1-3, vertical signal lines Vlin1 and Vlin2 are provided instead of the vertical signal line Vlin. The pixel PCn is connected to the vertical signal line Vlin1, and the pixel PCn+1 is connected to the vertical signal line Vlin2. A terminal T0 of a switch SWsig is connected to the capacitor C1, a terminal T1 of the switch SWsig is connected to the vertical signal line Vlin1, and a terminal T2 of the switch SWsig is connected to the vertical signal line Vlin2.

Level-shift acceleration transistors THB1 and THB2, load transistors TL1 and TL2, and a bias power supply VTL are provided in the level-shift acceleration load circuit 33. The drain of the level-shift acceleration transistor THB1 is connected to the vertical signal line Vlin1, the drain of the level-shift acceleration transistor THB2 is connected to the vertical signal line Vlin2, and the sources of the level-shift acceleration transistors THB1 and THB2 are grounded. The gates of the level-shift acceleration transistors THB1 and THB2 are connected to the terminal T0 of the switch SWsig.

The drain of the load transistor TL1 is connected to the vertical signal line Vlin1, the drain of the load transistor TL2 is connected to the vertical signal line Vlin2, and the sources of the load transistors TL1 and TL2 are grounded.

The switch SWsig is switched to the terminal T1 when the reset operation and the signal read operation of the pixel PCn are performed. An output voltage Vsig1 of the reset level and the read level of the pixel PCn is output through the vertical signal line Vlin1.

On the other hand, the switch SWsig is switched to the terminal T2 when the reset operation and the signal read operation of the pixel PCn+1 are performed. An output voltage Vsig2 of the reset level and the read level of the pixel PCn+1 is output through the vertical signal line Vlin2.

Therefore, the loads on the vertical signal lines Vlin1 and Vlin2 can be reduced to half compared with the load on the vertical signal line Vlin of FIG. 13, and the responsive property of the vertical signal line Vlin can be improved.

In the example of FIG. 15, two vertical signal lines Vlin1 and Vlin2 are provided in each column. Alternatively, N (N is an integer of 2 or more) vertical signal lines may be provided in each column. In this case, the pixels can be connected to the same vertical signal line at intervals of (N−1) in the column direction.

### Seventh Embodiment

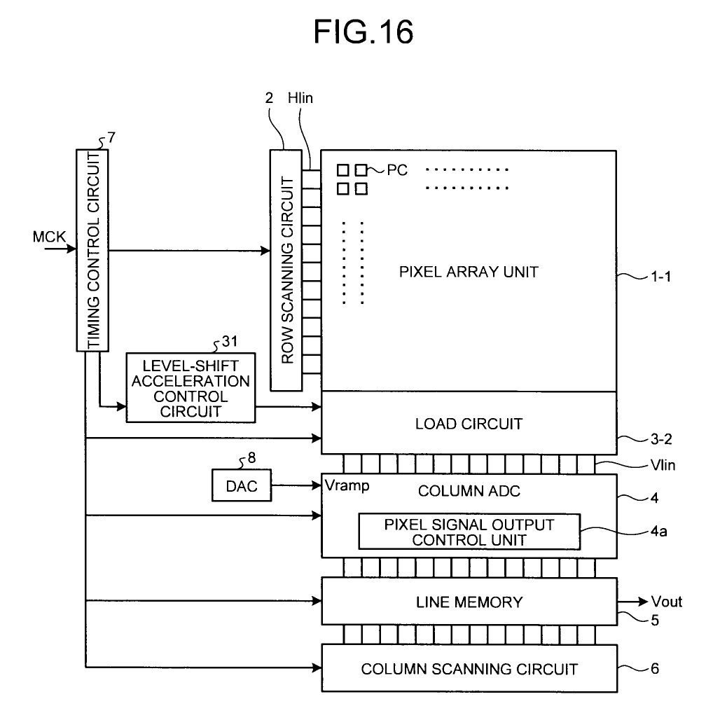

FIG. 16 is a block diagram illustrating a schematic configuration of a solid-state imaging device according to a seventh embodiment.

Referring to FIG. 16, in the solid-state imaging device, a load circuit 3-2 is provided instead of the level-shift acceleration circuit 32 and the load circuit 3-1 of the solid-state imaging device of FIG. 12.

The load circuit 3-2 can control the potential at the vertical signal line Vlin. The first-stage potential set through the load circuit 3-2 can correspond to the potential at the vertical signal line Vlin by the load circuit 3-1 of FIG. 8, the second-stage potential set through the load circuit 3-2 can correspond to the potential at the vertical signal line Vlin by the level-shift circuits 10-1 and 10-2 of FIG. 8, and the third-stage potential set through the load circuit 3-2 can correspond to the shift by the acceleration circuits 12-1 and 12-2 of FIG. 8

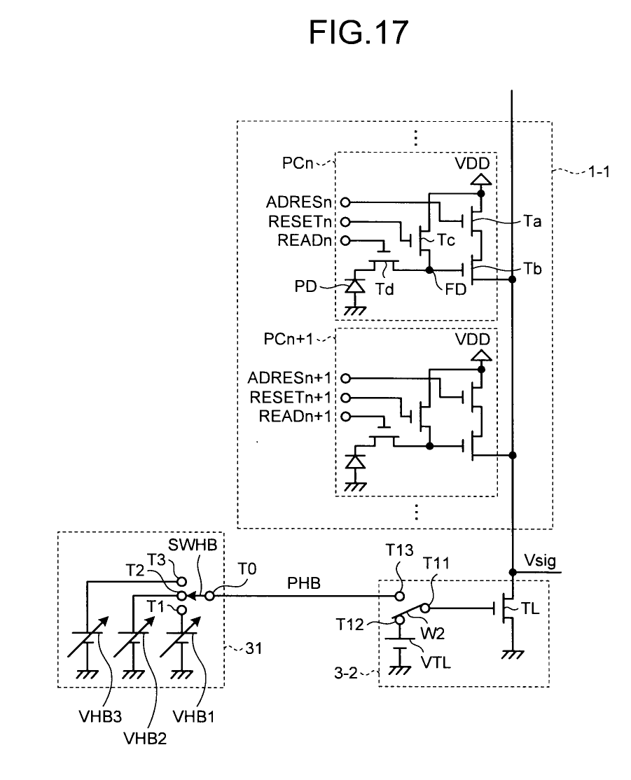

FIG. 17 is a circuit diagram illustrating a schematic configuration of one column of the solid-state imaging device of FIG. 16.

Referring to FIG. 17, in the solid-state imaging device, the load circuit 3-2 is provided instead of the level-shift acceleration circuit 32 and the load circuit 3-1 of FIG. 13.

In the load circuit 3-2, a switch W2 is added to the configuration of the load circuit 3-1. A terminal T11 of the switch W2 is connected to the gate of the load transistor TL, a terminal T12 of the switch W2 is connected to the bias power supply VTL, and a terminal T13 of the switch W3 is connected to the terminal T0 of the switch SWHB.

Referring to FIG. 14, when reset operation is performed while the selecting signal ADRESn is in the high-level state, the switch SWHB is switched to the terminal T3 after the switch W2 is switched to the terminal T13, whereby the level of the switching signal PHB is set to VHB3 and applied to the gate of the level-shift acceleration transistor THB.

When the gate potential at the load transistor TL is set to VHB3, the potential at the vertical signal line Vlin is drawn to the ground level, and the potential at the vertical signal line Vlin is reduced.

When the reset signal RESETn rises while the potential at the vertical signal line Vlin is reduced, the reset transistor Tc is turned on, and the extra charge generated by the leak current or the like is reset in the floating diffusion FD. Then, the switch SWHB is switched to the terminal T1, whereby the level of the switching signal PHB is set to VHB1 and applied to the gate of the load transistor TL.

When the gate potential at the load transistor TL is set to VHB1, the output voltage Vsig of the vertical signal line Vlin is shifted from the steady voltage Vr by the shift voltage Vb. At this point, the operating point of the comparator PA is set by applying the comparator zero setting pulse ADSW1 to the gate of the switch transistor Tsw1, and the operating point of the inverter V1 is set by applying the comparator zero setting pulse ADSW2 to the gate of the switch transistor Tsw2.

At this point, the charge corresponding to the shift voltage Vb is retained in the capacitors C1 and C2 while the output voltage Vsig of the vertical signal line Vlin is shifted, whereby the voltages of the comparator PA and the inverter V1 are set to zero.

The bias power supply VTL is connected to the gate of the load transistor TL by switching the switch W2 to the terminal T12, and the source follower is constructed by the amplification transistor Tb and the load transistor TL while the shift of the output voltage Vsig of the vertical signal line Vlin is released.

After the shift of the output voltage Vsig of the vertical signal line Vlin is released, the reset signal RESETn falls to turn off the reset transistor Tc. Because the source follower is constructed by the amplification transistor Tb and the load transistor TL, the voltage at the vertical signal line Vlin follows the voltage applied to the gate of the amplification transistor Tb, and the output voltage Vsig of the reset level is output to the vertical signal line Vlin.

When the signal read operation is performed while the row selecting transistor Ta of the pixel PCn is in the on-state, the switch SWHS is switched to the terminal T2 after the switch W2 is switched to the terminal T13, whereby the level of the switching signal PHB is set to VHB2 and applied to the gate of the load transistor TL.

When the gate potential at the load transistor TL is set to VHB2, the potential at the vertical signal line Vlin is drawn to the ground level, and the potential at the vertical signal line Vlin is reduced.

When the read signal READn rises while the potential at the vertical signal line Vlin is reduced, the read transistor Td is turned on, and the charge accumulated in the photodiode PD is transferred to the floating diffusion FD.

The bias power supply VTL is connected to the gate of the load transistor TL by switching the switch W2 to the terminal T12, and the source follower is constructed by the amplification transistor Tb and the load transistor TL. The voltage corresponding to the signal level of the floating diffusion FD is applied to the gate of the amplification transistor Tb, and voltage at the vertical signal line Vlin follows the voltage applied to the gate of the amplification transistor Tb, whereby the voltage applied to the gate of the amplification transistor Tb is output as the output voltage Vsig of the read level to the vertical signal line Vlin.

The load operation, the level-shift operation, and the acceleration operation can be performed by one load transistor TL by changing the gate potential at the load transistor TL to at least three stages, and the circuit scale can be reduced compared with the configuration of FIG. 13.

In the above embodiments, each of the comparator zero setting pulses ADSW1 and ADSW2 is applied twice. At this point, the second-time comparator zero setting pulse ADSW2 may not be applied because the first-time application of the comparator zero setting pulse ADSW2 is substantially equal to the second-time application of the comparator zero setting pulse ADSW2 in the charges accumulated in the capacitor C2.

The second-time comparator zero setting pulse ADSW1 may also be omitted. At this point, although the reset level is shifted by the shift voltage Vb, the down-count operation performed by the up/down counter UD is lengthened somewhat, which allows the shift voltage Vb to be cancelled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit in which pixels are two-dimensionally arrayed, a photoelectrically-converted charge being accumulated in the pixel;
a vertical signal line through which a pixel signal read from the pixel is vertically transmitted;
a level-shift circuit that shifts a potential at the vertical signal line;
a level-shift control circuit that controls an amount of shifted potential at the vertical signal line;
a timing control circuit that generates a control signal controlling the level-shift control circuit; and
a pixel signal output control unit that controls an output of the pixel signal based on a change in potential at the vertical signal line when the potential at the vertical signal line shifted by the level-shift circuit is used as a reference.

2. The solid-state imaging device according to claim 1, wherein the level-shift circuit shifts the potential at the vertical signal line when a reset level is read from the pixel through the vertical signal line.

3. The solid-state imaging device according to claim 2, wherein the pixel signal output control unit outputs a saturation signal as the pixel signal when the change in potential at the vertical signal line becomes equal to or more than a shift amount of the potential at the vertical signal line while the shift of the potential at the vertical signal line is released.

4. The solid-state imaging device as in any one of claims 1 to 3, wherein the level-shift circuit includes a level-shift transistor that shifts the potential at the vertical signal line, and the level-shift control circuit includes a switch that turns on/off the level-shift transistor.

5. The solid-state imaging device according to claim 4, wherein the level-shift control circuit includes a variable voltage source that changes a voltage applied when turning on the level-shift transistor.

6. The solid-state imaging device according to claim 1, wherein the level-shift circuits are vertically provided at both ends of the pixel array unit.

7. The solid-state imaging device according to claim 1, wherein the pixel includes: a photodiode that performs photoelectric conversion; a read transistor that transfers a signal from the photodiode to a floating diffusion; a reset transistor that resets the signal accumulated in the floating diffusion; and an amplification transistor that detects a potential at the floating diffusion.

8. The solid-state imaging device according to claim 7, further comprising a load transistor that constructs a source follower along with the amplification transistor.

9. The solid-state imaging device according to claim 1, further comprising: an acceleration circuit that previously shifts the potential at the vertical signal line before the signal is read from the pixel; and an acceleration control circuit that controls a time when the potential at the vertical signal line is previously shifted.

10. The solid-state imaging device according to claim 9, wherein the acceleration control circuit previously shifts the potential at the vertical signal line, when or immediately before a reset operation of the pixel is performed, or when or immediately before a read operation of the pixel is performed.

11. A solid-state imaging device comprising:
a pixel array unit in which pixels are two-dimensionally arrayed, a photoelectrically-converted charge being accumulated in the pixel;
a vertical signal line through which a pixel signal read from the pixel is vertically transmitted;
a level-shift circuit that shifts a potential at the vertical signal line;
a level-shift control circuit that controls an amount of shifted potential at the vertical signal line;
a timing control circuit that generates a control signal controlling the level-shift control circuit;
a black dot detection information storage unit in which black dot detection information is stored based on a change in potential at the vertical signal line when the potential at the vertical signal line shifted by the level-shift circuit is used as a reference; and
a pixel signal switching unit that switches an output of the pixel signal based on the black dot detection information.

12. The solid-state imaging device according to claim 11, wherein the level-shift circuit shifts the potential at the vertical signal line when a reset level is read from the pixel through the vertical signal line.

13. The solid-state imaging device according to claim 12, wherein the black dot detection information is stored in the black dot detection information storage unit when the change in potential at the vertical signal line becomes equal to or more than a shift amount of the potential at the vertical signal line while the shift of the potential at the vertical signal line is released.

14. A solid-state imaging device comprising:
a pixel array unit in which pixels are two-dimensionally arrayed, a photoelectrically-converted charge being accumulated in the pixel;
a vertical signal line through which a pixel signal read from the pixel is vertically transmitted;
a level-shift acceleration circuit that shifts a potential at the vertical signal line to at least two stages;
a level-shift acceleration control circuit that controls an amount of shifted potential at the vertical signal line;
a timing control circuit that generates a control signal controlling the level-shift acceleration control circuit; and
a pixel signal output control unit that controls an output of the pixel signal based on a change in potential at the vertical signal line when the potential at the vertical signal line shifted by the level-shift circuit is used as a reference.

15. The solid-state imaging device according to claim 14, wherein the level-shift acceleration circuit shifts the potential at the vertical signal line to at least two stages when a reset level is read from the pixel through the vertical signal line.

16. A solid-state imaging device comprising:
a pixel array unit in which pixels are two-dimensionally arrayed, a photoelectrically-converted charge being accumulated in the pixel;
a vertical signal line through which a pixel signal read from the pixel is vertically transmitted;
a load circuit that can control a potential at the vertical signal line;
a level-shift acceleration control circuit that controls a load amount of the load circuit;
a timing control circuit that generates a control signal controlling the level-shift acceleration control circuit; and
a pixel signal output control unit that controls an output of the pixel signal based on a change in potential at the vertical signal line when the potential at the vertical signal line controlled by the load circuit is used as a reference.

17. The solid-state imaging device according to claim 16, wherein the load circuit includes: a load transistor that is connected to the vertical signal line; and a switch that switches a voltage applied to a gate of the load transistor to at least three stages.

18. The solid-state imaging device according to claim 17, wherein the load transistor constructs a source follower along with the pixel when a signal is read from the pixel.

19. The solid-state imaging device according to claim 16, wherein the load circuit shifts the potential at the vertical signal line when a reset level is read from the pixel through the vertical signal line.

20. The solid-state imaging device according to claim 19, wherein the load circuit shifts the potential at the vertical signal line to at least three stages when the reset level is read from the pixel through the vertical signal line.
